(19) United States
(12) Patent Application Publication
(10) Pub. No.: US 2010/0054693 A1
(43) Pub. Date: Mar. 4, 2010

(54) APPARATUSES FOR AND METHODS OF PREVIEWING A MOVING PICTURE FILE IN DIGITAL IMAGE PROCESSOR

(75) Inventor: Su-jin Ryu, Suwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Digital Imaging Co., Ltd., Suwon-si (KR)

(21) Appl. No.: 12/545,179

(22) Filed: Aug. 21, 2009

(30) Foreign Application Priority Data
Aug. 28, 2008 (KR) 10-2008-0084744

(51) Int. Cl. H04N 5/93; G09G 5/00

(52) U.S. Cl. 386/52; 345/670; 386/E05.001

(57) ABSTRACT

Provided is a digital image processing apparatus and method. More particularly provided are apparatuses for and methods of previewing a moving picture file in a digital image processor which can extract and display frames at predetermined time intervals from a moving picture file. The apparatus includes a digital signal processing unit that extracts frames at predetermined time intervals from a selected moving picture file and sequentially displays the extracted frames.

### CROSS-REFERENCE TO RELATED PATENT APPLICATION

This application claims the benefit of Korean Patent Application No. 10-2008-0084744, filed on Aug. 28, 2008 in the Korean Intellectual Property Office, the contents of which is herein incorporated in its entirety.

### BACKGROUND OF THE INVENTION

1. Field of the Invention

The present invention relates to a digital image processing apparatus and method, and more particularly, to apparatuses for and methods of previewing a moving picture file in a digital image processor.

2. Description of the Related Art

A digital image processor may store many moving picture files. It may be difficult for a user to find a particular moving picture file among the many moving picture files. Some digital image processors display the first frame of the moving picture file to aid the user in recognizing a moving picture. However, the first frame may not be helpful in recognizing the moving picture file. Therefore, there is a need in the art for apparatuses and methods for previewing a motion picture file so that a user may recognize the contents of the motion picture file.

### SUMMARY OF THE INVENTION

The present invention provides an apparatus for and a method of previewing a moving picture file in a digital image processor so as to recognize the content of the moving picture file without entirely reproducing the moving picture file by extracting and displaying frames at predetermined time intervals.

According to embodiments of the present invention, an apparatus is provided for previewing a moving picture file in a digital image processor, the apparatus comprising a digital signal processing unit configured to: extract frames at predetermined time intervals from a selected moving picture file; and sequential display the extracted frames.

The digital signal processing unit may further configured to respond to receiving a reproduction signal, by reproducing the moving picture file.

The digital signal processing unit may comprise a frame extracting unit configured to extract frames at predetermined time intervals from the moving picture file; a slideshow executing unit configured to reproduce the extracted frames as a slideshow; and a control unit configured to: respond to receiving a frame extraction interval signal by controlling the frame extracting unit and the slideshow executing unit to display a slideshow of the moving picture file corresponding to the selected frame; and respond to receiving a reproduction signal by reproducing the moving picture file.

According to embodiments of the present invention, an apparatus is provided for previewing a moving picture file in a digital image processor, the apparatus comprising a digital signal processing unit configured to respond to the selection of a moving picture file in a thumbnail screen on which moving picture files and still image files are displayed, by extracting frames at predetermined time intervals from the selected moving picture file and shrinking the extracted frames to a thumbnail size, and sequentially displaying the shrunken frames.

The digital signal processing unit is further configured to: expand the thumbnail screen to a full-sized screen, and sequentially display the extracted frames on the full-sized screen, and respond to a reproduction signal by reproducing the moving picture file.

The digital signal processing unit comprises: a frame extracting unit configured to extract frames at predetermined time intervals from the moving picture file; a shrinking unit configured to shrink the extracted frames to a thumbnail size; a slideshow executing unit configured to reproduce the shrunken frames as a slideshow and configured to expand the slideshow into a full-screen slideshow; and a control unit configured to: respond to receiving a frame extraction interval signal, by controlling the frames extraction unit, the shrinking unit, and the slideshow executing unit to display a slideshow of the moving picture file corresponding to the selected frame; respond to a receiving an expand signal by controlling the slideshow executing unit to display a full-screen slideshow of the extracted frames; respond to receiving a reproduction signal by reproducing the moving picture file.

The digital signal processing unit may comprise a frame extracting unit configured to extract frames at predetermined time intervals from the moving picture file; a slideshow executing unit reproducing the extracted frames as a slideshow; a shrinking unit configured to shrink the frames reproduced as the slideshow to a thumbnail size; and a control unit configured to: respond to a frame extraction interval signal, by controlling the frame extracting unit and the slideshow executing unit to display a slideshow of the moving picture file corresponding to the selected frame on a full-sized screen; respond to receiving a reproduction signal by reproducing the moving picture file; and respond to a shrink signal, by controlling the shrinking unit, and the slideshow executing unit to display a thumbnail size slideshow of the moving picture file.

According to embodiments a method of previewing a moving picture file in a digital image processor is provided, the method comprising: extracting frames at predetermined time intervals from a selected moving picture file; and sequentially displaying the extracted frames.

The method may further comprise responsive to a reproduction signal, reproducing the moving picture file.

The sequential displaying of the extracted frames may further comprise reproducing the extracted frames as a slideshow.

According to embodiments a method of previewing a moving picture file in a digital image processor is provided, the method comprising: responsive to the selection of a moving picture file in a thumbnail screen on which moving picture files and still image files are displayed, extracting frames of the moving picture file at predetermined time intervals, shrinking the extracted frames to a thumbnail size, and sequentially displaying the shrunken frames.

The method may further comprise expanding the thumbnail size to a full-sized screen and responsive to receiving a reproduction signal, reproducing the moving picture file.

The sequential displaying of the shrunken frames may further comprise reproducing the shrunken frames as a slideshow.

According to embodiments of the present invention a method of previewing a moving picture file in a digital image processor is provided, the method comprising: responsive to the selection of a moving picture file in a thumbnail screen on which moving picture files and still image files are displayed, extracting frames of the moving picture file at predetermined time intervals; reproducing the extracted frames as a slideshow; and shrinking the reproduced frames as the slideshow and sequentially displaying the shrunken frames.

The method may further comprise expanding the thumbnail screen to a full-sized screen and responsive to a reproduction signal, reproducing the moving picture file.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view illustrating the front and top of an example of a digital image processor;

FIG. 2 is a rear view of the digital image processor of FIG. 1;

FIG. 3 is a block diagram of an example of an apparatus for previewing a moving picture file in the digital image processor of FIG. 1, according to an embodiment of the present invention;

FIG. 4 is a perspective view illustrating an example of frames being extracted and reproduced from a moving picture file of the apparatus of FIG. 3;

FIG. 5 is a block diagram of an example of an apparatus for reviewing a moving picture file in the digital image processor of FIG. 1, according to another embodiment of the present invention;

FIGS. 6A through 6E illustrate an example of frames being extracted and reproduced from a moving picture file of the apparatus of FIG. 3;

FIG. 7 is a flowchart illustrating an example of a method of previewing a moving picture file in the digital image processor of FIG. 1, according to an embodiment of the present invention; and

FIG. 8 is a flowchart illustrating an example of a method of previewing a moving picture file in the digital image processor of FIG. 1, according to another embodiment of the present invention.

### DETAILED DESCRIPTION OF THE INVENTION

The present invention will now be described more fully with reference to the accompanying drawings, in which exemplary embodiments of the invention are shown.

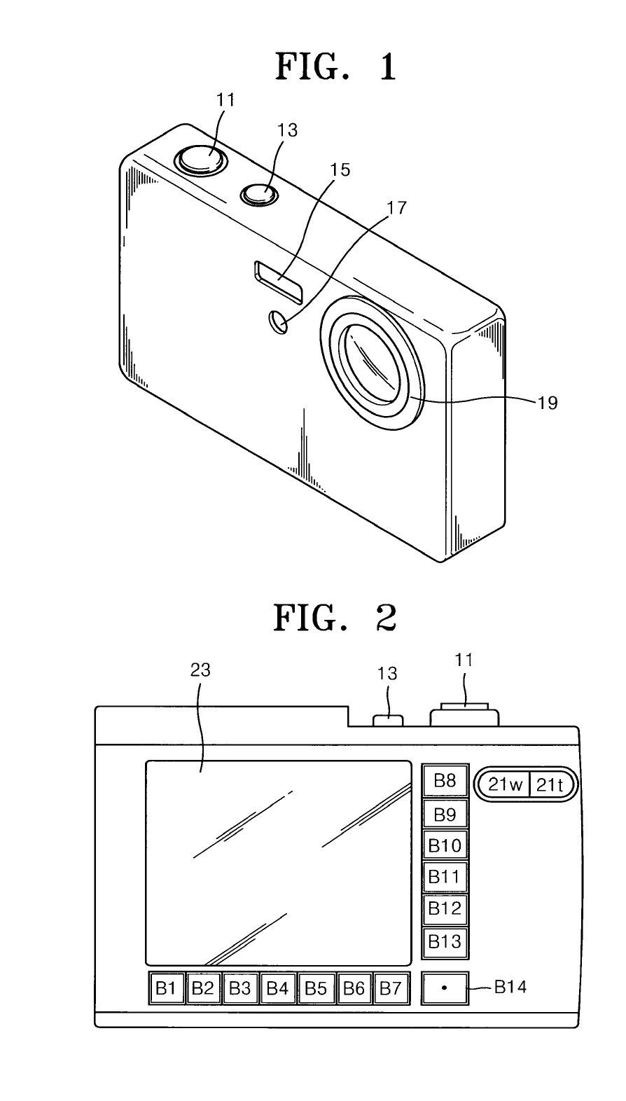

FIG. 1 is a perspective view illustrating the front and top of an example of a digital image processor.

In an embodiment, a shutter-release button 11 is opened and closed to expose a charge coupled device (CCD) or a film to light for a given period of time, and works together with an iris (not shown) to properly expose a subject and record an image on the CCD.

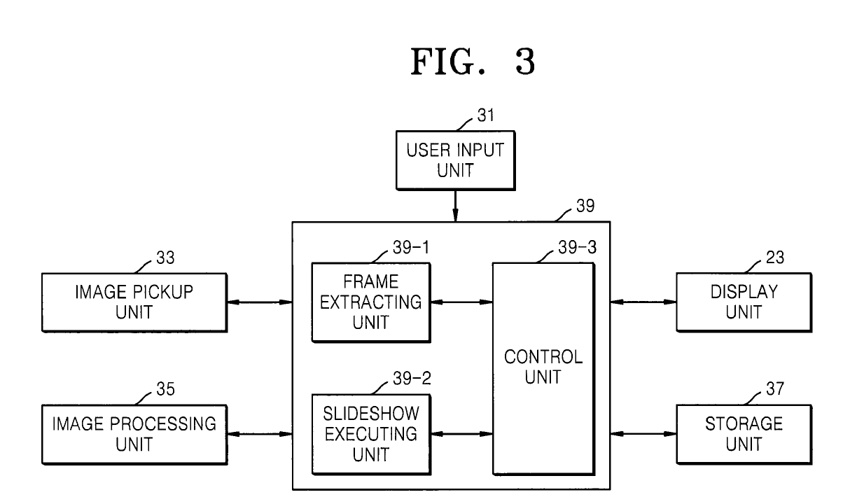

In embodiments, the shutter-release button 11 is pressed by a photographer to generate first and second image photograph signals. If the shutter-release button 11 is pressed halfway, the digital image processor focuses on a subject and adjusts the amount of light, and a display unit 23 (shown in FIG. 2) emits green light. Then, the shutter-release button 11 is pressed all the way to take an image.

In embodiments, a power button 13 is pressed to supply power to the digital image processor and operate the digital image processor.

In embodiments, a flash unit 15 produces an instantaneous flash of light to help illuminate a dark scene. Examples of a flash mode include an auto mode, a fill-in mode, a flash off-mode, a red-eye reduction mode, and a slow synchro mode.

In embodiments, an auxiliary light source 17 supplies light to the subject so that, in dark conditions, the digital image processor can automatically focus quickly and accurately.

In embodiments, a lens unit 19 receives light from an external light source and processes the image.

FIG. 2 is a rear view of the digital image processor of FIG. 1. In embodiments, the digital image processor includes a wide angle-zoom button 21w, a telephoto-zoom button 21t, the display unit 23, and buttons B1 through B14, each of which includes a touch sensor or a contact switch.

In embodiments, the wide angle-zoom button 21w or the telephoto-zoom button 21t increases or decreases the angle of view according to manipulation by the photographer. In particular, the wide angle-zoom button 21w and the telephoto-zoom button 21t are pressed to change the size of a selected exposure area. If the wide angle-zoom button 21w is pressed, the size of the selected exposure area is shrunk, and if the telephoto-zoom button 21t is pressed, the selected exposure area is enlarged.

In embodiments, the buttons B1 through B14 are aligned horizontally and vertically in the vicinity of the display unit 23. Each of the buttons B1 through B14 includes a touch sensor (not shown) or a contact switch (not shown).

For example, if each of the buttons B1 through B14 includes a touch sensor, when one of the horizontal buttons B1 through B7 or one of the vertical buttons B8 through B14 is touched, an item of a main menu, e.g., color or brightness, may be selected or an icon for a sub menu included in an icon for the main menu may be activated.

In embodiments, if each of the buttons B1 through B14 includes a contact switch, a desired function may be performed by directly selecting the icon for the main menu or the icon for the sub menu. In embodiments, the touch sensor requires a smaller amount of force than the contact switch.

FIG. 3 is a block diagram of an example of an apparatus for reviewing a moving picture file in the digital image processor of FIG. 1, according to an embodiment of the present invention. The apparatus includes the display unit 23, a user input unit 31, an image pickup unit 33, an image processing unit 35, a storage unit 37, and a digital signal processing unit 39.

In embodiments, the user input unit 31 includes the shutter-release button 11 that is opened and closed in order to expose a CCD or a film to light for a given period of time, the power button 13 that is pressed to supply power, the wide angle-zoom button 21w and the telephoto-zoom button 21 that are respectively pressed to widen and narrow the angle of view, and the buttons B1 through B4 that are aligned horizontally and vertically in the vicinity of the display unit 23 to input letters, select a menu, and execute the selected menu, each of the buttons B1 through B4 including a touch sensor or a contact switch.

In embodiments, the image pickup unit 33 includes a shutter (not shown), the lens unit 19, the iris, the CCD, and an analog-to-digital converter (ADC). The shutter cooperates with the iris to adjust the amount of light incident on the digital image processor. The lens unit 19 receives light from an external light source and processes an image. At this time, the iris adjusts the amount of incident light according to the size of an opening thereof. The size of the opening of the iris is controlled by the digital signal processing unit 39.

In embodiments, the CCD accumulates the light received by the lens unit 19, and outputs the image, which is processed by the lens unit 19 according to the accumulated light, according to a vertical synchronization signal. The digital image processor captures an image by using the CCD that converts light reflected by a subject into an electrical signal. In embodiments, in order to obtain a color image, the CCD employs a color filter, mostly a color filter array (CFA). The CFA is an array of color filters wherein each pixel passes only light having information about each color, and there are various types of CFA arrangements. The ADC converts an analog image signal output from the CCD into a digital signal.

In embodiments, the image processing unit 35 processes digitised RAW data to be displayed. The image processing unit 35 removes a black level caused by a dark current generated in the CCD and the CFA which are sensitive to a change in temperature. The image processing unit 35 performs gamma correction that encodes information because human vision has a nonlinear perceptual response to luminance. The image processing unit 35 performs CFA interpolation that interpolates a bayer pattern implemented in RGRG and GBGB lines of predetermined gamma corrected data to an RGB line. The image processing unit 35 converts an interpolated RGB signal into a YUV signal, performs edge compensation that filters a Y signal by using a high-pass filter to improve the sharpness of an image, and performs color correction that corrects colors of U and V signals by using a standard color coordinate system and removes noises from the U and V signals. In embodiments, the image processing unit 35 compresses and processes Y, U, and V signals from which noise is removed to generate a joint photographic experts group (JPEG) file, displays the generated JPEG file on the display unit 23, and stores the displayed JPEG file in the storage unit 37. In embodiments, all the operations of the image processing unit 35 are controlled by the digital signal processing unit 39.

In embodiments, the digital signal processing unit 39 extracts frames at predetermined time intervals from a selected moving picture file, sequentially displays the extracted frames, and then if a reproduction signal is received, entirely reproduces the moving picture file.

In embodiments, the digital signal processing unit 39 includes a frame extracting unit 39-1, a slideshow executing unit 39-2, and a control unit 39-3.

The frame extracting unit 39-1 extracts frames at predetermined time intervals from a selected moving picture under the control of the control unit 39-3. In embodiments, before the frames are extracted, a user may set frame extraction intervals to 1 second (by default), 2 seconds, or 3 seconds. In embodiments, the set frame extraction intervals are stored in the control unit 39-3.

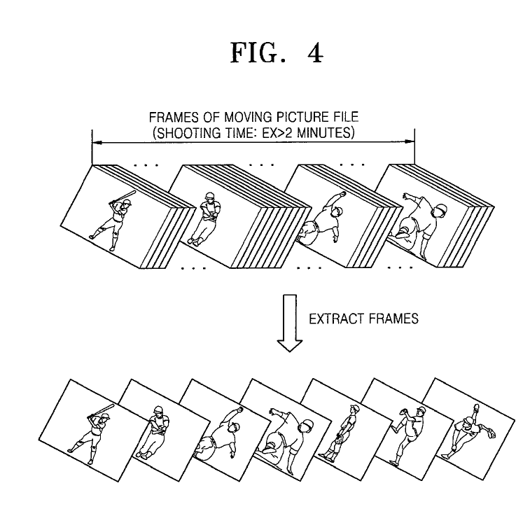

FIG. 4 is a perspective view illustrating an example of frames being extracted at set frame extraction intervals from a moving picture file that is obtained by taking moving pictures for 2 minutes. In embodiments, a moving picture file is divided into a moving picture file having a frame rate of 30 frames per second and a moving picture file having a frame rate of 15 frames per second. If the moving picture file of FIG. 4 has a frame rate of 30 frames per second, the number of frames included in a moving picture file that is obtained by taking moving pictures for 5 minutes is 2 (seconds)×60 (seconds)×30 (frames)=3600 (frames). For example, if the frame extraction intervals are set to 1 second, the number of frames extracted by the frame extracting unit 39-1 may be 120.

As shown in FIG. 4, the moving picture file includes frames, each of which in embodiments includes a header and data. In embodiments, there are three types of frame: an intra (I) frame, a predictive (P) frame, and a bidirectionary predictive (B) frame. The three types of frame are different from one another in terms of the definition of the header. An I frame is a frame that is encoded as a complete still image, thereby enabling continuous images to be formed by using P and B frames. P and B frames are frames having only movement information. In embodiments, the frame extracting unit 39-1 extracts I frames from 120 frames. In embodiments, the frame extracting unit 39-1 constructs frames from the P and/or B frames and the I frames.

In embodiments, the slideshow executing unit 39-2 sequentially reproduces the frames, which are extracted by the frame extracting unit 39-1, at set time intervals as a slideshow under the control of the control unit 39-3. In embodiments, if a reproduction/temporary stop button (not shown) of the user input unit 31 is pressed, the slideshow executing unit 39-2 reproduces or temporarily stops the slideshow.

In embodiments, the control unit 39-3 receives and stores frame extraction intervals set by the user, and controls the frame extracting unit 39-1 to extract frames at the set frame extraction intervals. In embodiments, the control unit 39-3 stores slideshow reproduction time intervals, and controls the slideshow executing unit 39-2 to reproduce the extracted frames as a slideshow at the stored slideshow reproduction time intervals. In embodiments, as the slideshow is reproduced, the user can recognize the content of the moving picture file without entirely reproducing the moving picture file. In embodiments, if a moving picture reproduction signal is received from the user after the slideshow is reproduced, the control unit 39-3 controls the moving picture file to be entirely reproduced.

FIG. 5 is a block diagram of an example of an apparatus for previewing a moving picture file in the digital image processor of FIG. 1, according to another embodiment of the present invention. The apparatus includes the display unit 23, the user input unit 31, the image pickup unit 33, the image processing unit 35, the storage unit 37, and the digital signal processing unit 39.

In embodiments, the display unit 23, the user input unit 31, the image pickup unit 33, the image processing unit 35, and the storage unit 37 of the apparatus of FIG. 5 are respectively the same as those of the apparatus of FIG. 3.

In embodiments, if a moving picture file is selected in a thumbnail screen on which moving picture files and still image files are displayed, the digital signal processing unit 39 extracts frames at predetermined time intervals from the selected moving picture file, shrinks the extracted frames to a thumbnail size, and sequentially displays the shrunken frames.

In embodiments, the digital signal processing unit 39 includes the control unit 39-3, a frame extracting unit 39-4, a frame shrinking unit 39-5, and a slideshow executing unit 39-6.

In embodiments, the frame extracting unit 39-1 extracts frames at predetermined time intervals from a moving picture file selected in a thumbnail screen under the control of the control unit 39-3. In embodiments, before the frames are extracted, the user may set frame extraction intervals to 1 second (by default), 2 seconds, or 3 seconds. In embodiments, the set frame extraction intervals are stored in the control unit 39-3.

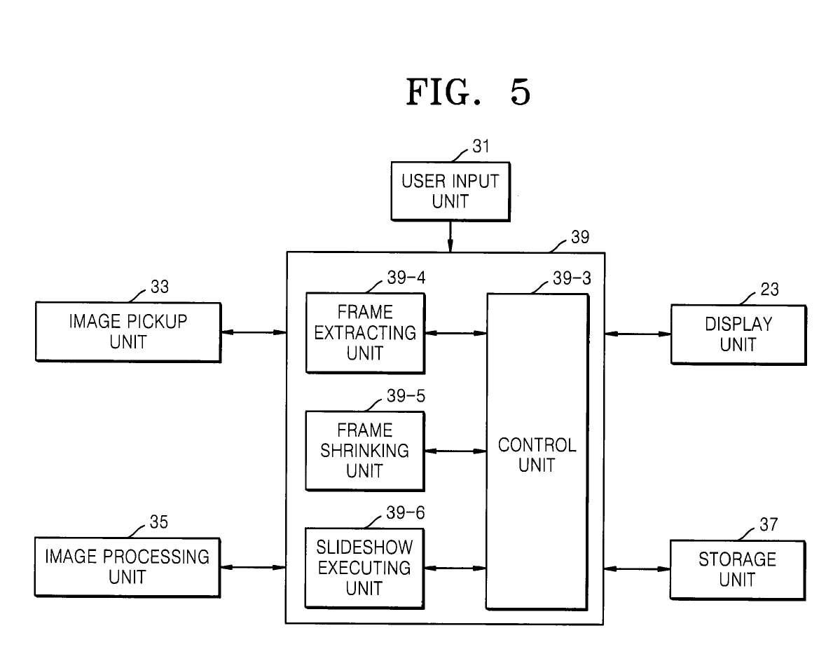

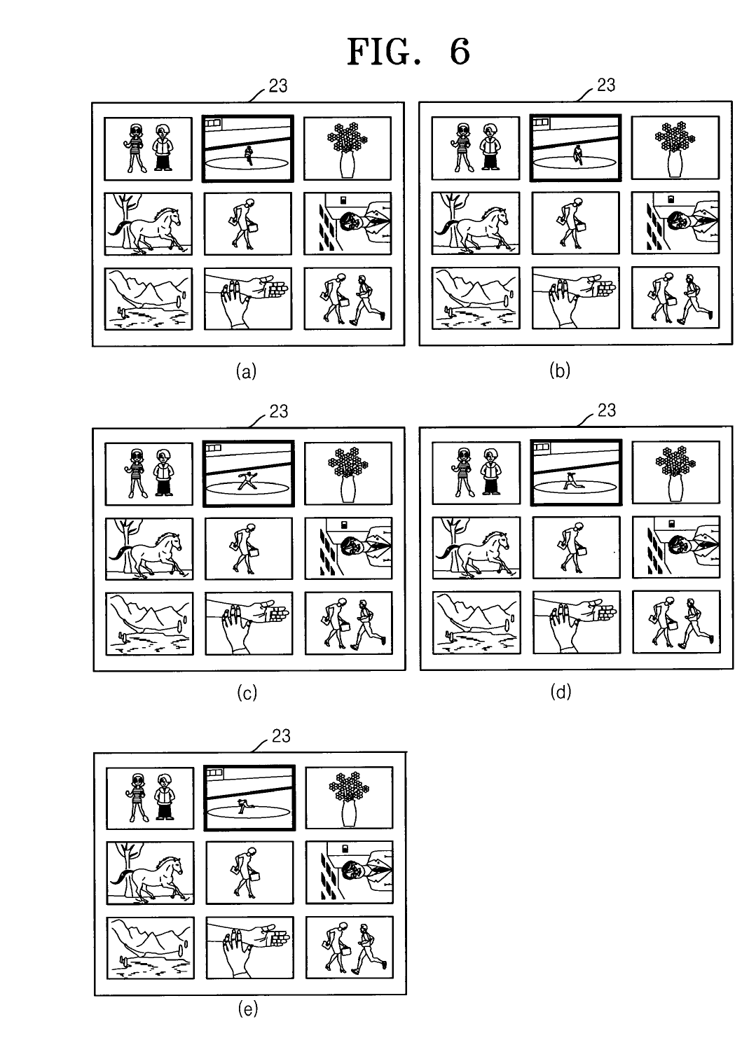

FIG. 6 illustrates an example of frames being extracted from a moving picture file selected in a thumbnail screen on which still images and moving pictures are displayed and being reproduced as a slideshow. In embodiments, if a moving picture file is selected in a thumbnail screen on which first frames of still image files and moving picture files are displayed, the frame extracting unit 39-4 extracts frames at set frame extraction intervals from the selected moving picture file.

In embodiments, a moving picture file includes frames, each of which includes a header and data. In embodiments, there are three types of frame: an I frame, a P frame, and a B frame. The three types of frame are different from one another in terms of the definition of header. An I frame is a frame that is encoded as a complete still image, thereby enabling continuous images to be formed by using P and B frames. P and B frames are frames having only movement information. In embodiments, the frame extracting unit 39-4 extracts I frames from the selected moving picture file. In embodiments, the frame extracting unit 39-4 extracts I frames that are near the time interval for extraction. For example, the extracting unit 39-4 may extract the nearest I frame after each time interval. In embodiments, the frame extracting unit 39-4 may select the nearest I frame to the time interval, so the I frame may come before or after the time interval. In embodiments, the frame extracting unit 39-4 extracts an I frame if the I frame is closer than a predetermined amount to the time interval, and otherwise the extracting unit 39-4 constructs a frame form the B and/or p and/or I frames to construct a frame closer to the time interval.

In embodiments, the frame shrinking unit 39-5 shrinks the frames, which are extracted by the frame extracting unit 36-4, to a thumbnail size. For example, since the display unit 23 has a size 640×480 and a thumbnail size of the display unit 23 is 160×120, the frame shrinking unit 39-5 shrinks the extracted frames to the thumbnail size. FIGS. 6B through 6E illustrate an example of frames, which are extracted from a selected moving picture file, being shrunk to a thumbnail size, and then displayed as a slideshow. Notice the top center image of the baseball pitcher changes between FIGS. 6B and 6E.

In embodiments, the slideshow executing unit 39-6 sequentially reproduces the frames, which are shrunk by the frame extracting unit 39-5, at set time intervals as a slideshow under the control of the control unit 39-3. In embodiments, if a reproduction/temporary stop button (not shown) of the user input unit 31 is pressed, the slideshow executing unit 39-6 may reproduce or temporarily stop the slideshow. FIGS. 6A through 6E illustrate an example of the frames of the selected moving picture file being shrunk to a thumbnail size and being reproduced as a slideshow.

Although the frame shrinking unit 39-5 shrinks the frames extracted by the frame extracting unit 39-4, the present invention is not limited thereto and the slideshow executing unit 39-6 may directly shrink and reproduce the extracted frames as a slideshow.

In embodiments, the control unit 39-3 receives and stores frame extraction intervals set by the user, and controls the frame extracting unit 39-1 to extract frames at the set frame extraction intervals. In embodiments, the control unit 39-3 stores slideshow reproduction time intervals, and controls the slideshow executing unit 39-2 to reproduce the frames, which are extracted at the slideshow reproduction time intervals, as a slideshow. In embodiments, the control unit 39-3 may shrink extracted frames to a thumbnail size and reproduce the shrunken frames as a slideshow, or may shrink frames, which are reproduced as a slideshow, and reproduce the shrunken frames. As the thumbnail-sized frames are reproduced as the slideshow, the user can recognize the content of the moving picture file without entirely reproducing the moving picture file. In embodiments, if a moving picture reproduction signal is received from the user after the thumbnail-sized frames are reproduced, the control unit 39-3 controls the thumbnail screen to be expanded to a full-sized screen and the moving picture file to be entirely reproduced. In embodiments, if a expand signal is received from the user (for example the user may touch the thumbnail image during a slideshow) the control unit 39-3 expands the thumbnail slideshow to a full-screen slideshow.

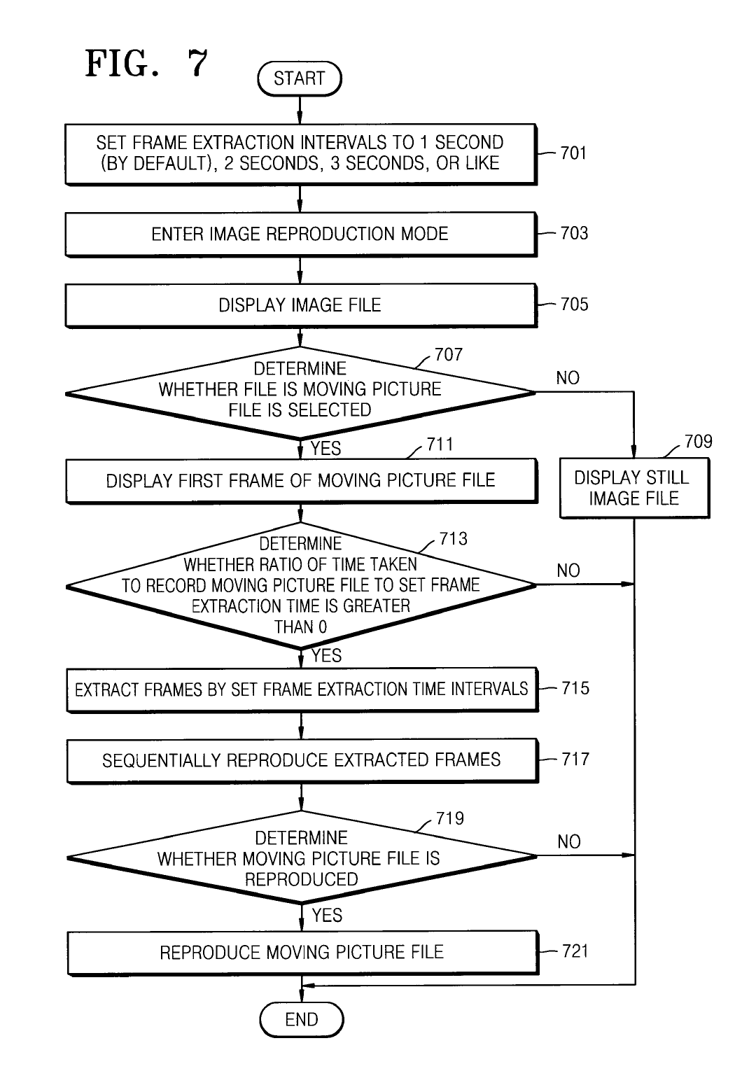

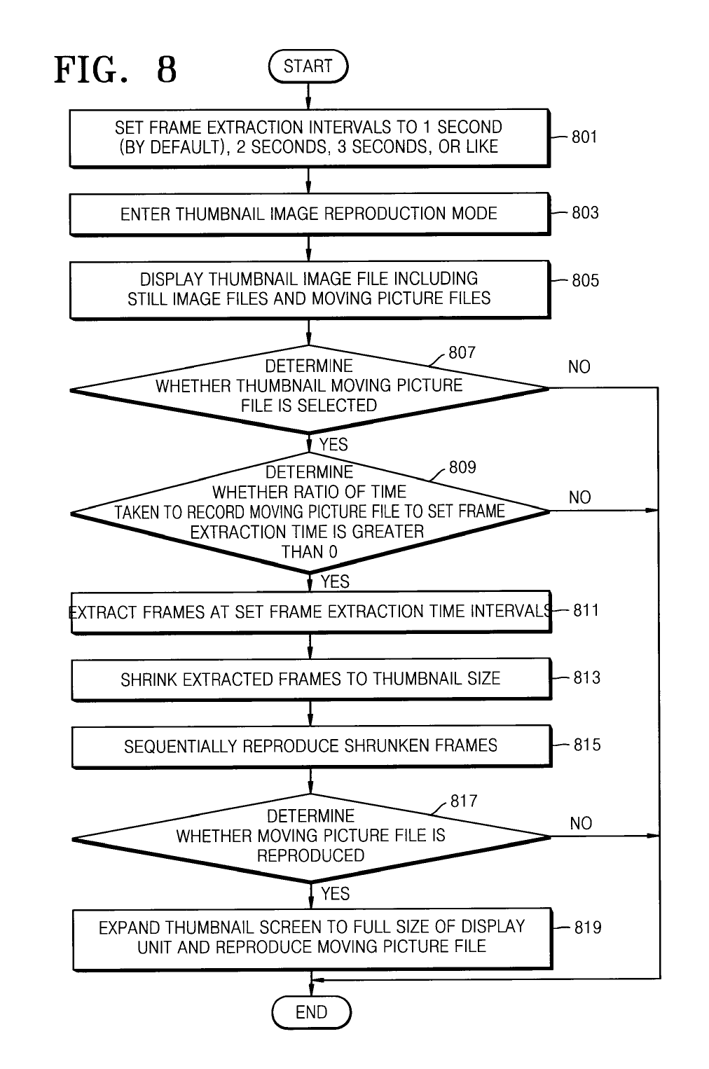

Examples of methods of previewing a moving picture file in the digital image processor of FIG. 1, according to embodiments of the present invention will now be explained in detail with reference to FIGS. 7 and 8. In embodiments, the methods may be performed inside the digital image processor as shown in FIGS. 3 and 5, and the methods may be performed by the digital signal processing unit 39 with the help of peripheral elements.

FIG. 7 is a flowchart illustrating an example of a method of previewing a moving picture file in the digital image processor of FIG. 1, according to an embodiment of the present invention.

In operation 701, if a moving picture preview menu is selected, the digital signal processing unit 39 receives a frame extraction interval signal from the user and sets frame extraction intervals. The user may set the frame extraction intervals to 1 second (by default), 2 seconds, or 3 seconds, and the set frame extraction intervals are stored in the digital signal processing unit 39.

In operation 703, the digital signal processing unit 39 enters an image reproduction mode. In operation 705, the digital signal processing unit 39 displays an image file on the display unit 23. The image file displayed on the display unit 23 may be a still image file and/or a moving picture file.

In operation 707, the digital signal processing unit 39 determines whether a moving picture file is selected. If it is determined in operation 707 that a still picture file is selected, the method proceeds to operation 709. In operation 709, the selected still image file is displayed.

If it is determined in operation 707 that a moving picture file is selected, however, the method proceeds to operation 711. In operation 711, a first frame of the selected moving picture file is displayed.

In operation 713, the digital signal processing unit 39 determines whether a ratio of a time taken to record the selected moving picture file to a set frame extraction time is greater than 0. If it is determined in operation 713 that the ratio is less than or equal to 1, then the entire contents of the moving picture file may be played.

If it is determined in operation 713 that the ratio is greater than 1, the method proceeds to operation 715. In operation 715, the digital signal processing unit 39 extracts frames at set frame extraction time intervals.

FIG. 4 illustrates an example of frames being extracted at set frame extraction intervals from a moving picture file that is obtained by taking moving pictures for 2 minutes. In embodiments, a moving picture file is divided into a moving picture file having a frame rate of 30 frames per second and a moving picture file having a frame rate of 15 frames per second. If the moving picture file of FIG. 4 has a frame rate of 30 frames per second, the number of frames included in a moving picture file that is obtained by taking moving pictures for 5 minutes is 2 (minutes)×60 (seconds)×30 (frames)=3600 (frames). For example, if the frame extraction intervals are set to 1 second, the number of frames extracted by the frame extracting unit 39-1 may be 120. As shown in FIG. 4, the example of a moving picture file includes frames, each of which includes a header and data. There are three types of frame: an I frame, a P frame, and a B frame. The three types of frame are different from one another in terms of the definition of header. An I frame is a frame that is encoded as a complete still image, thereby enabling continuous images to be formed by using P and B frames. P and B frames are frames having only movement information. Accordingly, the frame extracting unit 39-1 extracts I frames from 120 frames. In embodiments, the frame extracting unit 39-1 may select an I frame that is near the time interval. In embodiments, the frame extracting unit 39-1 may select the I frame that is closest to the time interval but not after the time interval. In embodiments, the frame extracting unit 30-1 may select the I frame that is closest to the time interval, but not before the time interval. In embodiments, the frame extracting unit may construct a frame near the time interval from P, and/or B, and I frames.

In operation 717, the digital signal processing unit 39 previews the moving picture file by sequentially reproducing the extracted frames as a slideshow. If a reproduction/temporary stop button of the user input unit 31 is pressed, the digital signal processing unit 39 may reproduce or temporarily stop the slideshow.

In operation 719, the digital signal processing unit 39 determines whether a moving picture file reproduction signal is received from the user. If it is determined in operation 719 that the moving picture file reproduction signal is received, the method proceeds to operation 721. In operation 721, the moving picture file is entirely reproduced.

As the moving picture file is previewed by sequentially reproducing the extracted frames as the slideshow, the user can recognize the content of the moving picture file without entirely reproducing the moving picture file.

FIG. 8 is an example of a method of previewing a moving picture file in the digital image processor of FIG. 1, according to another embodiment of the present invention.

In operation 801, if a moving picture preview menu is selected, the digital signal processing unit 39 receives a frame extraction interval signal from the user and sets frame extraction intervals. The user may set the frame extraction intervals to 1 second (by default), 2 seconds, or 3 seconds, and the set frame extraction intervals are stored in the digital signal processing unit 39.

In operation 803, the digital signal processing unit 39 enters a thumbnail image reproduction mode. In operation 805, the digital signal processing unit 39 displays a thumbnail image file including still image files and moving picture files on the display unit 23. FIG. 6A illustrates a thumbnail image file on which a still image file and a moving picture file are displayed.

In operation 807, the digital signal processing unit 39 determines whether a thumbnail moving picture file is selected. If it is determined in operation 807 that the thumbnail moving picture file is selected, the method proceeds to operation 809. In operation 809, a first frame of the selected thumbnail moving picture file is displayed, and the digital signal processing unit 39 determines whether a ratio of a time taken to record the selected moving picture file to a set frame extraction time is greater than 0.

If it is determined in operation 809 that the ratio is greater than 0, the method proceeds to operation 811. In operation 811, the digital signal processing unit 39 extracts frames at set frame extraction time intervals. An example of a process of extracting the frames has already explained in detail with reference to FIG. 7, and thus a detailed explanation thereof will not be given here.

In operation 813, the digital signal processing unit 39 shrinks the extracted frames to a thumbnail size. For example, since the display unit 23 has a size of 640×480 and the thumbnail image file displayed on the display unit 23 has a thumbnail size of 160×120, the digital signal processing unit 39 shrinks the extracted frames to the thumbnail size. FIGS. 6A through 6E illustrate examples of frames, which are extracted from a selected moving picture file, being shrunk to a thumbnail size. Notice the pitcher in the top center image changes through FIGS. 6B and 6E.

In operation 815, the digital signal processing unit 39 previews the selected moving picture file by sequentially reproducing the extracted frames as a slideshow. If a reproduction/temporary stop button of the user input unit 31 is pressed, the digital processing unit 39 may reproduce or temporarily stop the slideshow.

In embodiments, the digital signal processing unit 39 shrinks the extracted frames. In embodiments, the extracted frames may be shrunk and then reproduced as a slideshow.

In operation 817, the digital signal processing unit 39 determines whether a moving picture file reproduction signal is received from the user. If it is determined in operation 817 that the moving picture file reproduction signal is received from the user, the method proceeds to operation 819. In operation 819, the digital signal processing unit 39 expands the thumbnail screen to the full size of the display unit 23 and reproduces the moving picture file. In an embodiment, the digital signal processing unit 39 expands the thumbnail screen to the full size of the display unit 23 and displays the slideshow as a full-sized slideshow.

As the moving picture file is previewed on the thumbnail screen by sequentially reproducing the extracted frames as the slideshow, the user can recognize the content of the moving picture file without entirely reproducing the moving picture file.

As described above, since frames are extracted and displayed at predetermined time intervals, the content of a moving picture file can be conveniently recognized without entirely reproducing the moving picture file.

Embodiments comprise a computer readable medium encoded with computer-executable instructions to perform a method. The computer readable medium includes RAM memory, flash memory, ROM memory, EPROM memory, EEPROM memory, registers, a hard disk, a removable disk, a CD-ROM, or other forms of computer readable media known in the art.

For convenience, in the description above, the functionality described has been divided into a number of units; however, the number of units may vary and the functionality described above may be differently divided among the units, or the functionality described above may be implemented without units.

The various illustrative units described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. While the present invention has been particularly shown and described with reference to exemplary embodiments thereof, it will be understood by those of ordinary skill in the art that various changes in form and details may be made therein without departing from the spirit and scope of the present invention as defined by the following claims.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. An apparatus for previewing a moving picture file in a digital image processor, the apparatus comprising a digital signal processing unit configured to:
extract frames at predetermined time intervals from a selected moving picture file; and
sequential display the extracted frames.

2. The apparatus of claim 1, wherein the digital signal processing unit is further configured to:
respond to receiving a reproduction signal, by reproducing the moving picture file.

3. The apparatus of claim 2, wherein the digital signal processing unit comprises:
a frame extracting unit configured to extract frames at predetermined time intervals from the moving picture file;
a slideshow executing unit configured to reproduce the extracted frames as a slideshow; and
a control unit configured to:
respond to receiving a frame extraction interval signal by controlling the frame extracting unit and the slideshow executing unit to display a slideshow of the selected moving picture file; and
respond to receiving a reproduction signal by reproducing the selected moving picture file.

4. An apparatus for previewing a moving picture file in a digital image processor, the apparatus comprising a digital signal processing unit configured to:
respond to the selection of a moving picture file in a thumbnail screen on which moving picture files and still image files are displayed, by extracting frames at predetermined time intervals from the selected moving picture file and shrinking the extracted frames to a thumbnail size, and sequentially displaying the shrunken frames.

5. The apparatus of claim 4, wherein the digital signal processing unit is further configured to: expand the thumbnail screen to a full-sized screen, and sequentially display the extracted frames on the full-sized screen, and respond to a reproduction signal by reproducing the moving picture file.

6. The apparatus of claim 4, wherein the digital signal processing unit comprises:
a frame extracting unit configured to extract frames at predetermined time intervals from the moving picture file;
a shrinking unit configured to shrink the extracted frames to a thumbnail size;
a slideshow executing unit configured to reproduce the shrunken frames as a slideshow and configured to expand the slideshow into a full-screen slideshow; and
a control unit configured to:
respond to receiving a frame extraction interval signal, by controlling the frames extraction unit, the shrinking unit, and the slideshow executing unit to display a slideshow of the moving picture file;
respond to a receiving an expand signal by controlling the slideshow executing unit to display a full-screen slideshow of the moving picture file; and
respond to receiving a reproduction signal by reproducing the moving picture file.

7. The apparatus of claim 4, wherein the digital signal processing unit comprises:
a frame extracting unit configured to extract frames at predetermined time intervals from the moving picture file;
a slideshow executing unit configured to reproduce the extracted frames as a slideshow;
a shrinking unit configured to shrink the frames reproduced as the slideshow to a thumbnail size; and
a control unit configured to:
respond to a frame extraction interval signal, by controlling the frame extracting unit and the slideshow executing unit to display a slideshow of the moving picture file on a full-sized screen;
respond to receiving a reproduction signal by reproducing the moving picture file; and
respond to a shrink signal, by controlling the shrinking unit, and the slideshow executing unit to display a thumbnail size slideshow of the moving picture file.

8. A method of previewing a moving picture file in a digital image processor, the method comprising:
extracting frames at predetermined time intervals from a selected moving picture file; and
sequentially displaying the extracted frames.

9. The method of claim 8, further comprising responsive to a reproduction signal, reproducing the moving picture file.

10. The method of claim 8, wherein the sequential displaying of the extracted frames further comprises reproducing the extracted frames as a slideshow.

11. A method of previewing a moving picture file in a digital image processor, the method comprising:
responsive to the selection of a moving picture file in a thumbnail screen on which moving picture files and still image files are displayed, extracting frames of the moving picture file at predetermined time intervals,
shrinking the extracted frames to a thumbnail size, and
sequentially displaying the shrunken frames.

12. The method of claim 11, further comprising expanding the thumbnail size to a full-sized screen and responsive to receiving a reproduction signal, reproducing the moving picture file.

13. The method of claim 11, wherein the sequential displaying of the shrunken frames further comprises reproducing the shrunken frames as a slideshow.

14. A method of previewing a moving picture file in a digital image processor, the method comprising:
responsive to the selection of a moving picture file in a thumbnail screen on which moving picture files and still image files are displayed, extracting frames of the moving picture file at predetermined time intervals;
reproducing the extracted frames as a slideshow; and
shrinking the reproduced frames as the slideshow and sequentially displaying the shrunken frames.

15. The method of claim 14, further comprising expanding the thumbnail screen to a full-sized screen and responsive to a reproduction signal, reproducing the moving picture file.
